(19) United States
(12) Patent Application Publication
(10) Pub. No.: US 2009/0145105 A1
(43) Pub. Date: Jun. 11, 2009

(54) REMOTE ENGINE FUEL CONTROL AND ELECTRONIC ENGINE CONTROL FOR TURBINE ENGINE

(76) Inventors: Gabriel L. Suciu, Glastonbury, CT (US); Gary D. Roberge, Tolland, CT (US); Brian Merry, Andover, CT (US)

Correspondence Address: CARLSON, GASKEY & OLDS/PRATT & WHITNEY, 400 WEST MAPLE ROAD, SUITE 350, BIRMINGHAM, MI, 48009, US

(21) Appl. No.: 11/719,470

(22) PCT Filed: Dec. 1, 2004
(86) PCT No.: PCT/US04/40000

§ 371 Date: May 16, 2007

(51) Int. Cl. F02C 9/26

(52) U.S. Cl. 60/39.281

(57) ABSTRACT

A controller is mounted remotely from a turbine engine and provided with an independent power source (120, 138). The controller may be an engine controller (112) generating control signals based upon user inputs and sensor inputs, or a fuel controller (114) controlling a supply of fuel to the turbine engine (10), or both. Each controller includes a power source independent of the turbine engine, i.e. the power source supplies power even when the turbine and fan of the turbine engine (10) are not turning. A single wire harness and a single fuel line (118) connect the engine controller (112) and the fuel controller (114) to the turbine engine (10).

This invention was conceived in performance of U.S. Air Force contract F33657-03-C-2044. The government may have rights in this invention.

### BACKGROUND OF THE INVENTION

The present invention relates to turbine engines, and more particularly to a remote engine fuel controller and an electronic engine controller for a turbine engine, such as a tip turbine engine.

An aircraft gas turbine engine of the conventional turbofan type generally includes a forward bypass fan, a low pressure compressor, a middle core engine, and an aft low pressure turbine, all located along a common longitudinal axis. A high pressure compressor and a high pressure turbine of the core engine are interconnected by a high spool shaft. The high pressure compressor is rotatably driven to compress air entering the core engine to a relatively high pressure. This high pressure air is then mixed with fuel in a combustor, where it is ignited to form a high energy gas stream. The gas stream flows axially aft to rotatably drive the high pressure turbine, which rotatably drives the high pressure compressor via the high spool shaft. The gas stream leaving the high pressure turbine is expanded through the low pressure turbine, which rotatably drives the bypass fan and low pressure compressor via a low spool shaft.

Although highly efficient, conventional turbofan engines operate in an axial flow relationship. The axial flow relationship results in a relatively complicated elongated engine structure of considerable length relative to the engine diameter. This elongated shape may complicate or prevent packaging of the engine into particular applications.

A recent development in gas turbine engines is the tip turbine engine. Tip turbine engines may include a low pressure axial compressor directing core airflow into hollow fan blades. The hollow fan blades operate as a centrifugal compressor when rotating. Compressed core airflow from the hollow fan blades is mixed with fuel in an annular combustor, where it is ignited to form a high energy gas stream which drives the turbine that is integrated onto the tips of the hollow bypass fan blades for rotation therewith as generally disclosed in U.S. Patent Application Publication Nos.: 20030192303; 20030192304; and 20040025490. The tip turbine engine provides a thrust-to-weight ratio equivalent to or greater than conventional turbofan engines of the same class, but within a package of significantly shorter length.

Conventional gas turbine engines have an auxiliary gearbox where electrical generators, fuel pumps and other accessories are driven. However, the tip turbine engine does not have an accessory gearbox. Therefore, this type of architecture is not well-suited for tip turbine applications.

### SUMMARY OF THE INVENTION

In a turbine engine according to the present invention, a controller is mounted remotely from the turbine engine and provided with an independent power source. The controller may be an engine controller generating control signals based upon user inputs and sensor inputs, or a fuel controller controlling a supply of fuel to the turbine engine, or both. Each controller includes a power source independent of the turbine engine, i.e. the power source supplies power even when the turbine and fan of the turbine engine are not turning. A single wire harness and a single fuel line connect the engine controller and the fuel controller to the turbine engine.

Mounting the controllers remotely from the engine with independent power supplies is particularly advantageous in tip turbine engines because the tip turbine engines do not include an accessory gearbox and the packaging of the controllers in the tip turbine engine would be difficult without increasing the size of the tip turbine engine. However, the present invention is not limited to tip turbine engines. Additionally, the remote location of the controllers also facilitates the connection of the controllers to multiple turbine engines (tip turbine and/or conventional turbine engines), with a wiring harness and a fuel line connected to each.

### BRIEF DESCRIPTION OF THE DRAWINGS

Other advantages of the present invention can be understood by reference to the following detailed description when considered in connection with the accompanying drawings wherein:

FIG. 1 is a partial sectional perspective view of a tip turbine engine.

FIG. 2 is a longitudinal sectional view of the tip turbine engine of FIG. 1 along an engine centerline and a schematic view of an engine controller and fuel controller.

FIG. 3 schematically illustrates the engine controllers of FIG. 2 and a plurality of the turbine engines of FIGS. 1-2 installed in an aircraft.

### DETAILED DESCRIPTION OF THE PREFERRED EMBODIMENTS

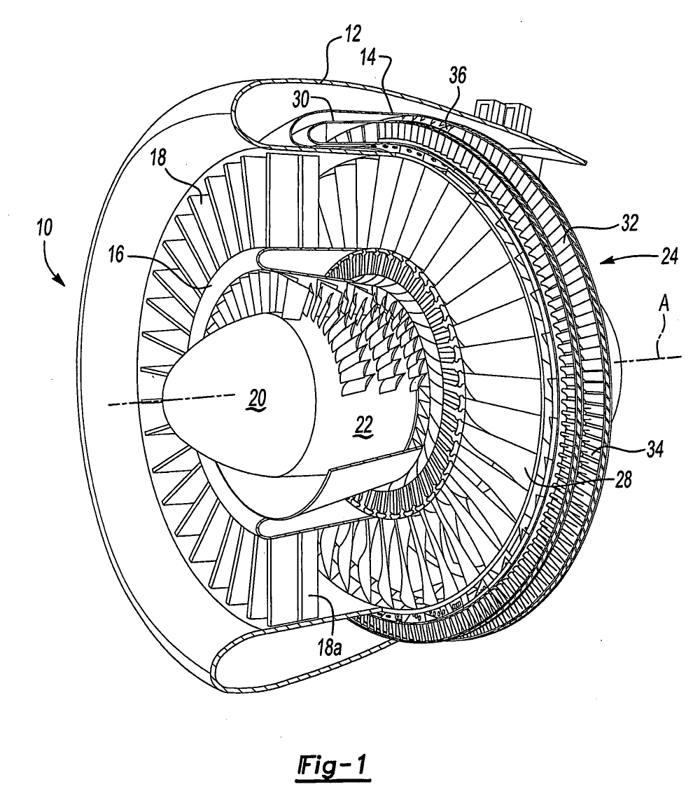

FIG. 1 illustrates a general perspective partial sectional view of a tip turbine engine (TTE) type gas turbine engine 10. The engine 10 includes an outer nacelle 12, a rotationally fixed static outer support structure 14 and a rotationally fixed static inner support structure 16. A plurality of fan inlet guide vanes 18 are mounted between the static outer support structure 14 and the static inner support structure 16. Each inlet guide vane preferably includes a variable trailing edge 18A. A nosecone 20 is preferably located along the engine centerline A to improve airflow into an axial compressor 22, which is mounted about the engine centerline A behind the nosecone 20.

A fan-turbine rotor assembly 24 is mounted for rotation about the engine centerline A aft of the axial compressor 22. The fan-turbine rotor assembly 24 includes a plurality of hollow fan blades 28 to provide internal, centrifugal compression of the compressed airflow from the axial compressor 22 for distribution to an annular combustor 30 located within the rotationally fixed static outer support structure 14.

A turbine 32 includes a plurality of tip turbine blades 34 (two stages shown) which rotatably drive the hollow fan blades 28 relative a plurality of tip turbine stators 36 which extend radially inwardly from the rotationally fixed static outer support structure 14. The annular combustor 30 is disposed axially forward of the turbine 32 and communicates with the turbine 32.

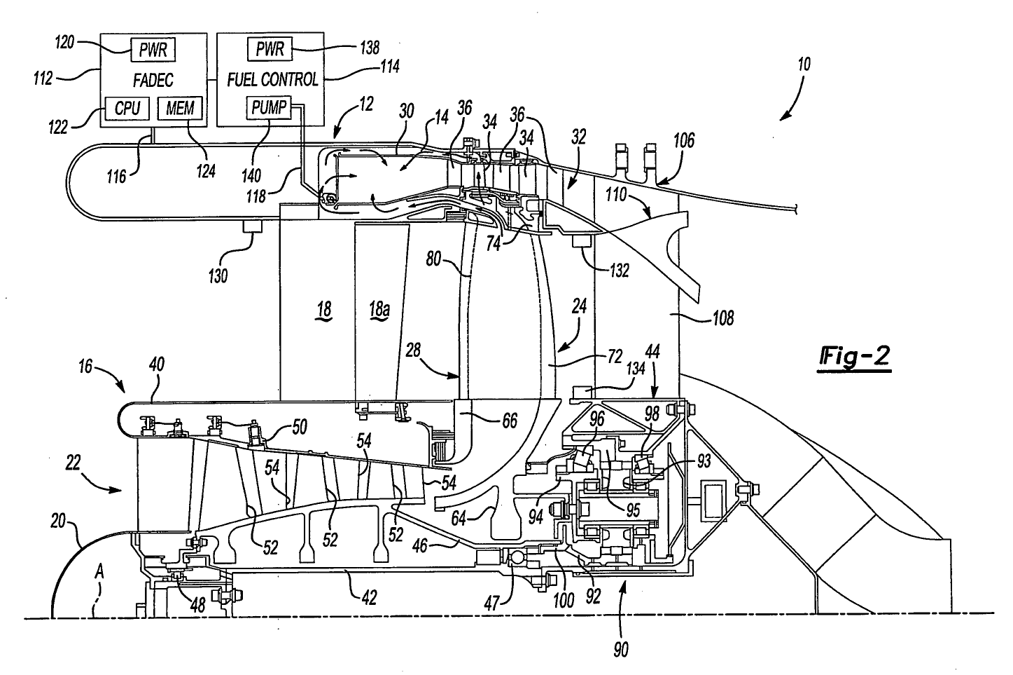

Referring to FIG. 2, the rotationally fixed static inner support structure 16 includes a splitter 40, a static inner support housing 42 and a static outer support housing 44 located coaxial to said engine centerline A.

The axial compressor 22 includes the axial compressor rotor 46, which is mounted for rotation upon the static inner support housing 42 through an aft bearing assembly 47 and a forward bearing assembly 48. A plurality of compressor blades 52 extend radially outwardly from the axial compressor rotor 46. A fixed compressor case 50 is mounted within the splitter 40. A plurality of compressor vanes 54 extend radially inwardly from the compressor case 50 between stages of the compressor blades 52. The compressor blades 52 and compressor vanes 54 are arranged circumferentially about the axial compressor rotor 46 in stages (three stages of compressor blades 52 and compressor vanes 54 are shown in this example).

The fan-turbine rotor assembly 24 includes a fan hub 64 that supports a plurality of the hollow fan blades 28. Each fan blade 28 includes an inducer section 66, a hollow fan blade section 72 and a diffuser section 74. The inducer section 66 receives airflow from the axial compressor 22 generally parallel to the engine centerline A and turns the airflow from an axial airflow direction toward a radial airflow direction. The airflow is radially communicated through a core airflow passage 80 within the fan blade section 72 where the airflow is centrifugally compressed. From the core airflow passage 80, the airflow is diffused and turned once again by the diffuser section 74 toward an axial airflow direction toward the annular combustor 30. Preferably, the airflow is diffused axially forward in the engine 10, however, the airflow may alternatively be communicated in another direction.

The tip turbine engine 10 may optionally include a gearbox assembly 90 aft of the fan-turbine rotor assembly 24, such that the fan-turbine rotor assembly 24 rotatably drives the axial compressor 22 via the gearbox assembly 90. In the embodiment shown, the gearbox assembly 90 provides a speed increase at a 3.34-to-one ratio. The gearbox assembly 90 is an epicyclic gearbox, such as a planetary gearbox as shown, that is mounted for rotation between the static inner support housing 42 and the static outer support housing 44. The gearbox assembly 90 includes a sun gear 92, which rotates the axial compressor rotor 46, and a planet carrier 94, which rotates with the fan-turbine rotor assembly 24. A plurality of planet gears 93 each engage the sun gear 92 and a rotationally fixed ring gear 95. The planet gears 93 are mounted to the planet carrier 94. The gearbox assembly 90 is mounted for rotation between the sun gear 92 and the static outer support housing 44 through a gearbox forward bearing 96 and a gearbox rear bearing 98. The gearbox assembly 90 may alternatively, or additionally, reverse the direction of rotation and/or may provide a decrease in rotation speed.

A plurality of exit guide vanes 108 are located between the static outer support housing 44 and the rotationally fixed exhaust case 106 to guide the combined airflow out of the engine 10. An exhaust mixer 110 mixes the airflow from the turbine blades 34 with the bypass airflow through the fan blades 28.

An upstream pressure sensor 130 measures pressure upstream of the fan blades 28 and a downstream pressure sensor 132 measures pressure downstream of the fan blades 28. A rotation speed sensor 134 is mounted adjacent the fan blades 28 to determine the rotation speed of the fan blades 28. The rotation speed sensor 134 may be a proximity sensor detecting the passage of each fan blade 28 to calculate the rate of rotation.

In operation, core airflow enters the axial compressor 22, where it is compressed by the compressor blades 52. The compressed air from the axial compressor 22 enters the inducer section 66 in a direction generally parallel to the engine centerline A, and is then turned by the inducer section 66 radially outwardly through the core airflow passage 80 of the hollow fan blades 28. The airflow is further compressed centrifugally in the hollow fan blades 28 by rotation of the hollow fan blades 28. From the core airflow passage 80, the airflow is turned and diffused axially forward in the engine 10 by the diffuser section 74 into the annular combustor 30. The compressed core airflow from the hollow fan blades 28 is mixed with fuel in the annular combustor 30 and ignited to form a high-energy gas stream.

The high-energy gas stream is expanded over the plurality of tip turbine blades 34 mounted about the outer periphery of the fan-turbine rotor assembly 24 to drive the fan-turbine rotor assembly 24, which in turn rotatably drives the axial compressor 22 either directly or via the optional gearbox assembly 90. The fan-turbine rotor assembly 24 discharges fan bypass air axially aft to merge with the core airflow from the turbine 32 in the exhaust case 106.

Control of the tip turbine engine 10 is provided by a Full Authority Digital Engine Controller (FADEC) 112 and by a fuel controller 114, both mounted remotely from the tip turbine engine 10 (i.e. outside the nacelle 12) and connected to the tip turbine engine 10 by a single wiring harness 116 and a single fuel line 118, respectively. The FADEC 112 includes a dedicated power source 120 that is independent of the tip turbine engine 10. In other words, the power source 120 supplies power even when the tip turbine engine 10 is not running. The power source 120 may be a battery that is re-charged by a generator (not shown) powered by the tip turbine engine 10, a fuel cell, or other electric generator. The FADEC 112 includes a CPU 122 and memory 124 for executing control algorithms to generate control signals to the tip turbine engine 10 and the fuel controller 114 based upon input from the upstream pressure sensor 130, the downstream pressure sensor 132 and the rotation speed sensor 134. The control signals may include signals for controlling the position of the variable trailing edges 18A of the inlet guide vanes 18, commands that are sent to the fuel controller 114 to indicate the amount of fuel that should be supplied and other necessary signals for controlling the tip turbine engine 10.

The fuel controller 114 also includes a dedicated power source 138 that is independent of the tip turbine engine 10. In other words, the power source 138 supplies power even when the tip turbine engine 10 is not running. The power source 138 may be a battery that is re-charged by a generator (not shown) powered by the tip turbine engine 10 a fuel cell, or other electric generator. The fuel controller 114 includes at least one fuel pump 140 for controlling the supply of fuel to the tip turbine engine 10 via fuel line 118.

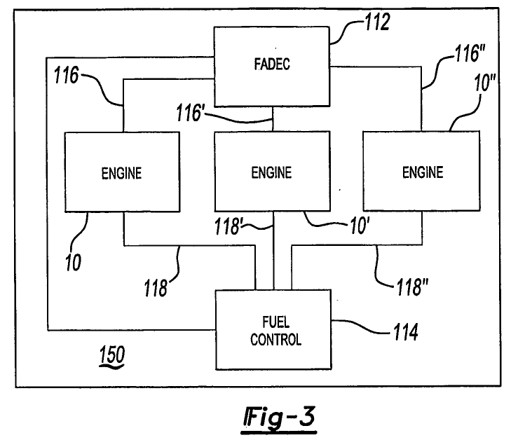

FIG. 3 schematically illustrates the engine controllers 112, 114 controlling a plurality of the turbine engines 10, 10′, 10″ of FIGS. 1-2 (and/or conventional turbine engines) installed in an aircraft 150. Mounting the controllers 112, 114 remotely from the tip turbine engine 10 keeps the configuration of the tip turbine engine 10 as simple and as small as possible. Also, one or both of the controllers 112, 114 could be connected to additional tip turbine engines 10′, 10″ via additional wiring harnesses 116′, 116″ and fuel lines 118′, 118″, as shown. Thus, multiple tip turbine engines 10, 10′, 10″ in a single aircraft 150 could be controlled by a single FADEC 112 and/or a single fuel controller 114.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope.

1. A turbine engine and controller comprising:
a fan including a plurality of fan blades;
a combustor burning fuel to generate a high-energy gas stream;
a turbine downstream from the combustor, the turbine rotatably drivable by the high-energy gas stream; and
a controller for controlling the engine, the controller located remotely from the turbine engine.

2. The turbine engine and controller of claim 1 wherein the controller includes a power source.

3. The turbine engine and controller of claim 2 wherein the power source is independent of the turbine engine.

4. The turbine engine and controller of claim 3 wherein the controller is a fuel controller controlling a supply of fuel to the turbine engine.

5. The turbine engine and controller of claim 4 wherein the controller includes a fuel pump.

6. The turbine engine and controller of claim 5 further including a bypass air flow path through which air is driven upon rotation of the plurality of fan blades, wherein the controller is disposed radially outward of the bypass air flow path.

7. The turbine engine and controller of claim 6 further including an axial compressor radially inward of the bypass air flow path.

8. The turbine engine and controller of claim 1 further including a bypass air flow path driven through the fan by rotation of the plurality of fan blades, at least one sensor within the bypass air flow path, wherein the controller is an engine controller receiving a sensor signal from the at least one sensor, the controller generating control signals based upon the sensor signal, the controller sending the control signals to the turbine engine.

9. The turbine engine and controller of claim 8 wherein the engine controller includes a power source.

10. The turbine engine and controller of claim 9 wherein the power source is independent of the turbine engine.

11. The turbine engine and controller of claim 10 further including a fuel controller controlling a supply of fuel to the turbine engine, the fuel controller located remotely from the turbine engine

12. The turbine engine and controller of claim 11 wherein the fuel controller includes a fuel pump.

13. The turbine engine and controller of claim 12 wherein the engine controller includes a power source independent of the turbine engine.

14. The turbine engine of claim 1 wherein at least one of the plurality of fan blades defines a centrifugal compressor chamber therein for compressing core airflow therein and guiding the compressed core airflow toward the combustor.

15. A turbine engine and controller comprising:
a bypass fan including a plurality of fan blades for drawing bypass air flow through a bypass air flow path, at least one of the fan blades defining a centrifugal compressor chamber therein for centrifugally compressing core airflow;
a combustor burning fuel mixed with the compressed core airflow from the centrifugal compressor chamber to generate a high-energy gas stream;
a turbine downstream from the combustor, the turbine rotatably driven by the high-energy gas stream, the turbine rotatably driving the bypass fan; and
a controller for controlling operation of the engine, the controller being powered by a power source independent of the turbine engine.

16. The turbine engine and controller of claim 15 wherein the controller is a fuel controller controlling a supply of the fuel to the combustor.

17. The turbine engine and controller of claim 16 wherein the fuel controller includes a fuel pump.

18. The turbine engine and controller of claim 15 wherein the controller is disposed radially outward of the bypass air flow path.

19. The turbine engine and controller of claim 15 further including an axial compressor radially inward of the bypass air flow path, the axial compressor communicating core airflow to the centrifugal compressor chamber.

20. The turbine engine and controller of claim 15 further including at least one sensor within the bypass air flow path, wherein the controller is an engine controller receiving a sensor signal from the at least one sensor, the controller generating control signals based upon the sensor signal, the controller sending the control signals to the turbine engine.
